(19) United States
(12) Patent Application Publication
(10) Pub. No.: US 2022/0076134 A1
(43) Pub. Date: Mar. 10, 2022

(54) TWO-STAGE DEEP LEARNING BASED SECURE PRECODER FOR INFORMATION AND ARTIFICIAL NOISE SIGNAL IN NON-ORTHOGONAL MULTIPLE ACCESS SYSTEM

(71) Applicant: Korea Advanced Institute of Science and Technology, Daejeon (KR)

(72) Inventors: Jeongseok HA, Daejeon (KR); Jinyoung LEE, Daejeon (KR)

(73) Assignee: Korea Advanced Institute of Science and Technology, Daejeon (KR)

(21) Appl. No.: 17/317,633

(22) Filed: May 11, 2021

(30) Foreign Application Priority Data
Sep. 4, 2020 (KR) 10-2020-0113165
Mar. 31, 2021 (KR) 10-2021-0041667

(51) Int. Cl. G06N 3/08; G06K 9/62

(52) U.S. Cl. CPC G06N 3/088; G06K 9/6256; G06N 3/084

(57) ABSTRACT

A learning method for a two-stage deep learning base secure precoder for information and an artificial noise signal in a non-orthogonal multiple access (NOMA) system is provided. The learning method for designing the two-stage deep learning based secure precoder for the information and the artificial noise signal in the NOMA system may include performing pre-training for downlink NOMA before information transmission to maximize a sum secrecy rate while ensuring secrecy rates of respective legitimate users, each having a single antenna (secrecy fairness), and performing post-training by fine tuning a neural network learned by the pre-training using unsupervised learning.

### CROSS-REFERENCE TO RELATED APPLICATIONS

A claim for priority under 35 U.S.C. § 119 is made to Korean Patent Application No. 10-2020-0113165 filed on Sep. 4, 2020, and Korean Patent Application No. 10-2021-0041667 filed on Mar. 31, 2021, in the Korean Intellectual Property Office, the entire contents of which are hereby incorporated by reference.

### BACKGROUND

Embodiments of the inventive concept described herein relate to a two-stage deep learning based secure precoder for information and an artificial noise signal in a non-orthogonal multiple access (NOMA) system.

Non-orthogonal multiple access (NOMA) is one of promising technologies toward 6G, which is a technology recently and actively being researched. This is in the spotlight as a technology capable of meeting various communication requirements such as a low delay time, high reliability, huge connectivity, and improved fairness. Because this is able to use limited communication resources at high efficiency, this is regarded as an important multiple access technology to be used in the coming 6G era and is reflected in communication standard [6G].

A core idea of the NOMA system supports a communication service of multiple users in one of a time resource, a frequency resource, or a code resource. Because the NOMA system is a system supporting a communication service of a plurality of users using power hierarchy multiplexing in a single resource, interference with signals is more increased than the existing orthogonal multiple access (OMA). Successive interference cancellation (SIC) is used in the NOMA to remove such interference.

It is possible to detect information of multiple users allocated to a single source by using the SIC. In other words, an overlapped signal may be removed by using the SIC. In detail, a receiver using the SIC first detects a signal having the strongest signal level among the overlapped signals and handles the other signals as noise. Thereafter, the receiver removes the detected strongest signal from the overlapped signals and detects the next stronger signal to remove the detected signal from the overlapped signals. As such, the detected amount of information is determined according to a power difference between information of users in the NOMA system which uses the SIC.

Unlike the existing cryptography-based security scheme, a physical layer security technology is a new security scheme using physical characteristics of wireless communication environments, which is in spotlight as a new security scheme capable of being combined into an Internet of things (IoT) or the like toward 6G era. Techniques about physical layer security are combined into various wireless communication systems to proceed, but a physical layer security technique for downlink NOMA is not much developed yet. Particularly, there is no research about the design of a precoder considering secrecy fairness between paired users in the NOMA.

### REFERENCES

[6G] Kai Yang, Nan Yang, Neng Ye, Min Jia, Zhen Gao, Rongfei Fan, “Non-Orthogonal Multiple Access: Achieving Sustainable Future Radio Access”, IEEE Communications Magazine, vol. 57, no. 2, February 2019. 2019.
[Feng] Y. Feng, S. Yan, Z. Yang, N. Yang, and J. Yuan, “Beamforming design and power allocation for secure transmission with NOMA,” IEEE Trans. Wireless Commun., vol. 18, no. 5, pp. 2639-2651, May 2019.
[GAN] P. Lin, S. Lai, S. Lin, and H. Su, “On secrecy rate of the generalized artificial-noise assisted secure beamforming for wiretap channels,” IEEE J. Sel. Areas Commun., vol. 31, no. 9, pp. 1728-1740, Sep. 2013.

### SUMMARY

Embodiments of the inventive concept provide a deep learning based secure precoder for maximizing a sum secrecy rate while ensuring secrecy rates of respective paired users when an eavesdropper attempts to eavesdrop in a non-orthogonal multiple access (NOMA) system. Furthermore, Embodiments of the inventive concept provide a two-stage secure precoder scheme capable of performing fast learning.

According to an exemplary embodiment, a learning method for a two-stage deep learning based secure precoder for information and an artificial noise signal in a non-orthogonal multiple access (NOMA) system may include performing pre-training for downlink NOMA before information transmission to maximize a sum secrecy rate while ensuring secrecy rates of respective legitimate users, each having a single antenna and performing post-training by fine tuning a neural network learned by the pre-training using unsupervised learning.

The performing of the pre-training may include performing the pre-training using a loss function. The loss function may be defined with regard to a probability that a secrecy rate obtained by a secure precoder according to a channel of each legitimate user will be less than a secrecy rate the legitimate user should ensure and the secrecy rate obtained by the secure precoder.

A loss function according to the post-training may be defined as the following formula,

[symbol]

ₚₒₛₜ=−Rₛ₁−Rₛ₂+c₁(max[G₁+ϵ₁−Rₛ₁,0])²+c₂(max[G₂+ϵ₂−Rₛ₂,0])²

, where Rₛₖ denotes the achievable secrecy rate for the secure precoder, cₖ denotes the penalty coefficient, and denotes the margin of the secrecy rate of each legitimate user and where k=the first legitimate user 1, the second legitimate user 2, and the artificial noise N.

The performing of the post-training may include performing training using the margin of the secrecy rate of each legitimate user to minimize a probability that a secrecy rate obtained by a secure precoder according to a channel of each legitimate user will be less than a secrecy rate the legitimate user should ensure.

The learning method may further include updating a weight matrix and a bias vector using a stochastic gradient descent (SGD) scheme, when updating the weight matrix and the bias vector in a backpropagation scheme using a loss function according to the pre-training and a loss function according to the post-training.

According to an exemplary embodiment, a learning device for a two-stage deep learning based secure precoder for information and an artificial noise signal in a non-orthogonal multiple access (NOMA) system may include a pre-training performing unit that performs pre-training for downlink NOMA before information transmission to maximize a sum secrecy rate while ensuring secrecy rates of respective legitimate users, each having a single antenna and a post-training performing unit that performs post-training by fine tuning a neural network learned by the pre-training using unsupervised learning.

According to an exemplary embodiment, a learning method for a two-stage deep learning based secure precoder for information and an artificial noise signal in a non-orthogonal multiple access (NOMA) system may include performing pre-training for downlink non-orthogonal multiple access (NOMA) before information transmission to maximize a sum secrecy rate while ensuring secrecy rates of respective legitimate users, each having a single antenna and performing post-training by fine tuning a neural network learned by the pre-training using unsupervised learning. The performing of the post-training may include performing training using a margin of a secrecy rate of each legitimate user to minimize a probability that a secrecy rate obtained by a secure precoder according to a channel of each legitimate user will be less than a secrecy rate the legitimate user should ensure.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a flowchart illustrating a learning method for a two-stage deep learning based secure precoder for information and an artificial noise signal in a non-orthogonal multiple access (NOMA) system according to an embodiment of the inventive concept;

FIG. 2 is a drawing illustrating a neural network structure for designing a secure precoder in a NOMA system according to an embodiment of the inventive concept;

FIG. 3 is a block diagram illustrating a configuration of a learning device for a two-stage deep learning based secure precoder for information and an artificial noise signal in a NOMA system according to an embodiment of the inventive concept;

FIG. 4 is a drawing illustrating an experimental result for a pairing success probability according to an embodiment of the inventive concept;

FIG. 5 is a drawing illustrating an experimental result for a sum secrecy rate according to an embodiment of the inventive concept;

FIG. 6 is a drawing illustrating the result of comparing performance of a two-stage training scheme with performance of a one-stage training scheme using only post-training according to an embodiment of the inventive concept; and

FIG. 7 is a drawing illustrating performance according to a change in position of an eavesdropper according to an embodiment of the inventive concept.

### DETAILED DESCRIPTION

An embodiment of the inventive concept relates to an optimal secure precoding design using deep learning, which is one of artificial intelligence schemes, and more particularly, relates to a deep learning based secure precoder design with regard to secrecy fairness of a paired user in a single cell downlink non-orthogonal multiple access (NOMA) system. Hereinafter, embodiments of the inventive concept will be described in detail with reference to the accompanying drawings.

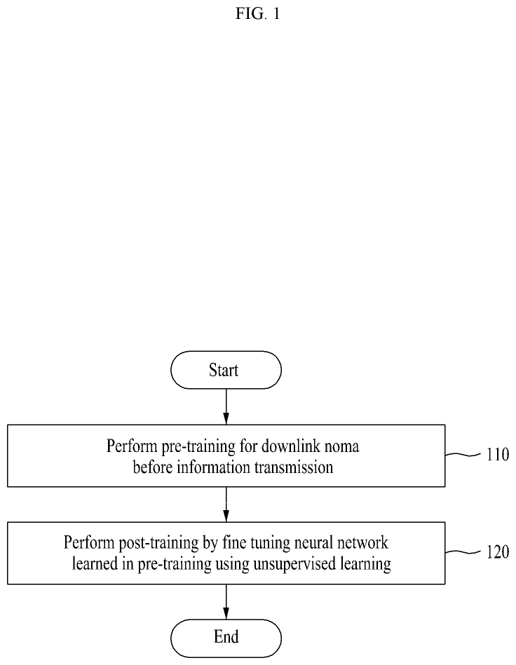

FIG. 1 is a flowchart illustrating a learning method for a two-stage deep learning based secure precoder for information and an artificial noise signal in a NOMA system according to an embodiment of the inventive concept.

An embodiment of the inventive concept may propose a scheme of designing a secure precoder with regard to a channel between a base station and a legitimate user and a maximum transmit power of the system to maximize a sum secrecy rate while ensuring secrecy rates of respective legitimate users, when an eavesdropper attempts to eavesdrop. By means of the secure precoder design provided by an embodiment of the inventive concept, the embodiment of the inventive concept may ensure secrecy rates of the respective legitimate users, which are not considered by the existing downlink precoder design scheme, and may maximize a sum secrecy rate, when an eavesdropper attempts to eavesdrop. Furthermore, an embodiment of the inventive concept may propose a practical deep learning based precoder design scheme available irrespective of a position of a legitimate user and a position of an eavesdropper to address a problem of existing high complexity of calculation. In addition, an embodiment of the inventive concept may propose s two-stage secure precoder facilitating more efficient learning in the deep learning based precoder to address a problem of a learning time.

Referring to FIG. 1, a learning method for a two-stage deep learning based secure precoder for information and an artificial noise signal in a NOMA system may include performing (110) pre-training which is a supervised learning scheme for downlink NOMA before information transmission to maximize a sum secrecy rate while ensuring secrecy rates of respective legitimate users, each having a single antenna, and performing (120) post-training which is an unsupervised learning scheme by fine tuning a neural network learned by the pre-training using unsupervised learning.

An embodiment of the inventive concept may propose a scheme of designing a precoder for maximizing a sum secrecy rate while ensuring secrecy rates of respective legitimate users irrespective of positions of the legitimate users and positions of eavesdroppers in a situation where the eavesdropper eavesdrops in the downlink NOMA as a neural network (NN) structure which uses a deep learning technique, which is one of schemes implementing artificial intelligence. A learning scheme for the deep learning precoder may be designed as two-stage learning including a first stage of performing pre-training which is the supervised learning scheme and a second stage of performing post-training which is the unsupervised learning scheme.

When there is another unintended receiver in a network, that is, when there is an eavesdropper, the NOMA system for physical layer security according to an embodiment of the inventive concept may obtain a maximum secrecy rate while ensuring secrecy rates of respective legitimate users, each having a single antenna.

To this end, the secure precoder design for the downlink NOMA should be performed prior to an information transmission stage.

Successive interference cancellation (SIC) used in NOMA may detect information of multiple users who share a single source with each other and may minimize interference with an increased signal compared to the existing orthogonal multiple access (OMA). Thus, it is essential to design a precoder different from the existing OMA system with regard to the SIC and a characteristic of the system in the NOMA system.

When using the SIC in an uplink NOMA system, the amount of information of each of multiple users allocated to a single resource may be determined by channels of users, a transmit power, and the precoder. However, when there is an eavesdropper as well as a legitimate user in a NOMA network, a secrecy rate which is a degree to which it is unable to eavesdrop as well as data rates of users may be a system parameter.

Thus, when an eavesdropper attempts to eavesdrop, the NOMA system in an embodiment of the inventive concept may proposes a deep learning based precoder design scheme capable of obtaining a maximum secrecy rate while ensuring a secrecy rate of each legitimate user.

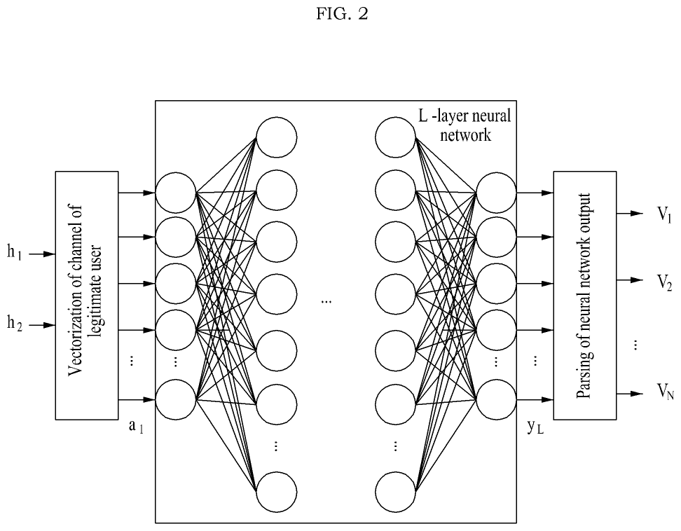

FIG. 2 is a drawing illustrating a neural network structure for designing a secure precoder in a NOMA system according to an embodiment of the inventive concept.

It is assumed that a communication system considered in an embodiment of the inventive concept is composed of a base station having multiple antennas, two single antenna legitimate users who receive a communication service, and one eavesdropper. In this case, the eavesdropper having a single antenna may eavesdrop on signals of the legitimate user.

Hereinafter, a description will be given of a downlink NOMA system model and a secrecy rate according to an embodiment of the inventive concept.

A non-orthogonal system where there are one base station, two legitimate users, and one eavesdropper in a single cell is assumed. The base station may be composed of antenna N_{A}, and the legitimate users and the eavesdropper may be composed of a single antenna. In Equation 1 below, a channel vector between the legitimate users in the base station is represented as hₖ, k∈{1,2}, and a channel vector between the base station and the eavesdropper is represented as hₑ. Herein, the channel may be designed as an element which considers both of path loss and small scale fading.

$${h}_{k} = {d}_{k}^{- \frac{α}{2}} {g}_{k} , {h}_{e} = {d}_{e}^{- \frac{α}{2}} {g}_{e} , \qquad [ Equation 1 ]$$

Herein, dₖ,dₑ respectively denote the distance between the base station and the legitimate user k and the distance between the base station and the eavesdropper. Furthermore, α denotes the path loss exponent, and gₖ˜ [symbol] (0,1) and gₑ˜ [symbol] (0,1) denote the elements of the small scale fading of the Rayleigh distribution. The magnitude of the channel vector may be 0<|h₁|≤|h₂| and the channel vector may be ordered according to magnitude.

The base station may use superimposed coding to transmit an information signal sₖ of legitimate users and an artificial noise vector s_{N}. The transmission vector may be represented as Equation 2 below.

$$x = {{\sum }^{2}}_{k = 1} {v}_{k} {s}_{k} + {V}_{N} {s}_{N} , \qquad [ Equation 2 ]$$

Herein, vₖsₖ and V_{N}S_{N} respectively denote the precoded information signal of the legitimate user and the artificial noise signal. In this case, the entire transmit power is limited to P_{T} like Equation 3 below.

$$Tr ( {\sum }_{k = 1}^{2} {S}_{{u}_{k}} + {S}_{{v}_{N}} ) \leq {P}_{T} \qquad [ Equation 3 ]$$

The receive signal yₖ in the legitimate user k may be represented as Equation 4 below.

$${y}_{k} = {h}_{k} x + {n}_{k} = {h}_{k} ( {{\sum }^{2}}_{k = 1} {v}_{k} {s}_{k} + {V}_{N} {s}_{N} , ) + {n}_{k} , \qquad [ Equation 4 ]$$

Herein, nₖ˜ [symbol] (0,σₖ²) denotes the additive white Gaussian noise (AWGN). The receive signal yₑ in the eavesdropper may be represented as Equation 5 below.

$${y}_{e} = {h}_{e} ( {{\sum }^{2}}_{k = 1} {v}_{k} {s}_{k} + {V}_{N} {s}_{N} , ) + {n}_{e} , \qquad [ Equation 5 ]$$

Herein, nₑ˜ [symbol] (0,σₑ²) denotes the additive white Gaussian noise (AWGN) in the eavesdropper.

The legitimate user and the eavesdropper in the non-orthogonal system may use a successive interference cancellation (SIC) reception scheme. The rate achievable in the legitimate user k may be represented as Equation 6 below.

$${R}_{b , k} = {log}_{2} ( 1 + \frac{{h}_{k} {v}_{k} {v}_{k}^{H} {h}_{k}^{H}}{{σ}_{k}^{2} + {h}_{k} ( {{\sum }^{2}}_{i = k + 1} {v}_{i} {v}_{i}^{H} + {V}_{N} {V}_{N}^{H} ) {h}_{k}^{H}} ) . \qquad [ Equation 6 ]$$

Furthermore, the most pessimistic situation is assumed to design a robust secure precoder. It is assumed that the eavesdropper may remove interference between users, which is generated by an information signal. The rate achievable in the eavesdropper may be represented as Equation 7 below.

$${R}_{e , k} = {log}_{2} ( 1 + \frac{{h}_{e} {v}_{k} {v}_{k}^{H} {h}_{e}^{H}}{{σ}_{e}^{2} + {h}_{e} {V}_{N} {V}_{N}^{H} {h}_{e}^{H}} ) . \qquad [ Equation 7 ]$$

In an optimization problem definition about a precoder design of maximizing the secrecy rate, the achievable secrecy rate for the secure precoder in the legitimate user k may be defined as Equation 8 below.

R_{s,k}(v₁,v₂,V_{N})= [symbol] [R_{b,k}(v₁,v₂,V_{N})−R_{e,k}(v₁,v₂,V_{N})] [Equation 8]

The sum secrecy rate of the legitimate users may be represented as Equation 9 below.

$${R}_{s} ( {v}_{1} , {v}_{2} , {V}_{N} ) = {{\sum }^{2}}_{k = 1} {R}_{s , k} ( {v}_{1} , {v}_{2} , {V}_{N} ) . \qquad [ Equation 9 ]$$

An embodiment of the inventive concept may design a secure precoder of maximizing the sum secrecy rate while considering secrecy fairness of the legitimate users. Thus, the secure precoder to be designed in an embodiment of the inventive concept may be defined as the following optimization problem like Equation 10 below.

(v₁^{opt},v₂^{opt},V_{N}^{opt})=argmaxᵥ_{₁}_{,v}_{₂}_{,V}_{_{N}}Rₛ(v₁,v₂,V_{N})

s.t. Tr(Sᵤ₁+Sᵤ₂+Sᵥ)≤P_{T},

R_{s,1}≥G_{s,1},

R_{s,2}≥G_{s,2}, [Equation 10]

Herein, G_{s,k} denotes the secrecy rate the legitimate user k should ensure. Because the above optimization problem is a nonconvex-nonlinear problem, it is very difficult to analytically and numerically solve the optimization problem. The above problem may be found using an exhaustive search scheme, but, because the exhaustive search scheme is very high in complexity, it may be degraded in practicality and efficiency. Thus, in an embodiment of the inventive concept, a deep learning scheme may be used to effectively address the above problem.

The deep learning based secure precoder design scheme according to an embodiment of the inventive concept may reconstruct the above optimization problem as Equation 11 below to learn a neural network.

(v₁^{opt},v₂^{opt},V_{N}^{opt}=argmaxᵥ_{₁}_{,v}_{₂}_{,V}_{_{N}}Rₛ(v₁,v₂,V_{N})−cP(v₁,v₂,V_{N})

s.t. Tr(Sᵤ₁+Sᵤ₂+Sᵥ)≤P_{T}, [Equation 11]

Herein, c denotes the penalty coefficient and P(⋅) denotes the penalty function. The penalty function P (v₁ v₂, V_{N}) may be represented as Equation 12 below.

$$P ( {v}_{1} , {v}_{2} , {V}_{N} ) = {{\sum }^{2}}_{k = 1} ( {max [ {G}_{s , k} - {R}_{s , k} ( {v}_{1} , {v}_{2 ,} {V}_{N} ) , 0 ]}^{2} ) . \qquad [ Equation 12 ]$$

When the respective legitimate users meet the allocated secrecy rate, the penalty is not applied to the optimization problem as P(v₁,v₂,V_{N})=0.

The deep learning is used to design the secure precoder which is the solution of the above optimization problem. In the neural network structure shown in FIG. 2, channels of the legitimate user are designed as inputs h₁,h₂, and the secure precoder is designed as outputs v₁, v₂, V_{N}. A relationship between the input and output in the hidden layer l in the neural network structure is represented as Equation 13 below.

yₗ=ψₗ(Wₗaₗ+bₗ),l∈{1, . . . ,L} [Equation 13]

Herein, Wₗ and bₗ respectively denote the weight matrix and the bias vector in the lth hidden layer. Furthermore, ψₗ and aₗ respectively denote the input and the activation function in the lth hidden layer. Thus, the final output in the neural network is represented as Equation 14 below.

y_{L}=ψ_{L}(W_{L} . . . ψₗ(W₁a₁+b₁) . . . +b_{L}), [Equation 14]

Herein, y_{L}==[v₁^{T},v₁^{T},vec(V_{N})^{T}]^{T} denotes the output of the neural network, which refers to the secure precoder. Furthermore, vec(⋅) denotes the vectorization of the matrix.

The loss function is needed to learn a neural network. In an embodiment of the inventive concept, the neural network may be learned through two stages. First of all, supervised learning may be performed using the [Feng19] algorithm, which is the latest research of the secure precoder according to an embodiment of the inventive concept, in the existing NOMA. This scheme is referred to as pre-training. Thereafter, the learned neural network may be fine-tuned using unsupervised learning. The second scheme is referred to as post-training. The loss function according to each learning stage may be defined as Equations 15 and 16 below.

The loss function according to pre-training may be defined as Equation 15 below.

[symbol]

ₚᵣₑ=∥v₁−v₁^{Feng}∥₂+∥v₂−v₂^{Feng}∥₂+∥V_{N}−V_{N}^{Feng}∥_{F} [Equation 15]

The loss function according to post-training may be defined as Equation 16 below.

[symbol]

ₚₒₛₜ=−Rₛ₁−Rₛ₂+c₁(max[G₁+ϵ₁−Rₛ₁,0])²+c₂(max[G₂+ϵ₂−Rₛ₂,0])² [Equation 16]

Herein, v₁^{Feng},v₂^{Feng},V_{N}^{Feng} indicate the secure precoder produced by the [Feng] algorithm. The penalty coefficient c₁,c₂ is set to

$$\frac{{G}_{1} + {G}_{2}}{{ϵ}_{1}^{2}} , \frac{{G}_{1} + {G}_{2}}{{ϵ}_{2}^{2}} ,$$

and the margin ϵ₁,ϵ₂ of the secrecy rate of each legitimate user is set to 0.019G₁,0.15G₂. In this case, the reason why the neural network is learned using ϵ₁,ϵ₂ is to learn the neural network in a manner which minimizes a probability that the secrecy rate capable of being obtained through the secure precoder according to the input channel of each legitimate user will be less than the secrecy rate the legitimate users should ensure. The margin of a secure outage probability of each person is given to learn the neural network to learn the neural network in the direction of minimizing the secure outage probability of each legitimate user.

There is a limit to a transmit power in an embodiment of the inventive concept: Tr(Sᵤ₁+Sᵤ₂+Sᵥ)≤P_{T}. Thus, when updating the weight matrix and the bias vector using a backpropagation scheme using the loss function, a stochastic gradient descent (SGD) scheme like Equation 17 below may be used.

$$Ω ← \{ \begin{matrix}Ω - α ∇ ℒ ( Ω ) , & {‖ {y}_{L} ‖}^{2} \leq {P}_{T} \\ \sqrt{{P}_{T}} \frac{Ω - α ∇ ℒ ( Ω )}{‖ Ω - α ∇ ℒ ( Ω ) ‖} , & otherwise\end{matrix} \qquad [ Equation 17 ]$$

Herein, α>0 indicates the learning rate or the step size for update.

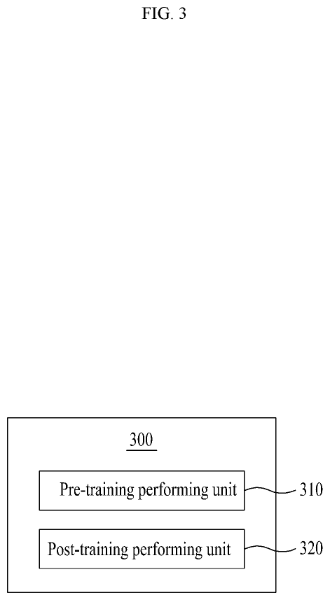

FIG. 3 is a block diagram illustrating a configuration of a learning device for a two-stage deep learning based secure precoder for information and an artificial noise signal in a NOMA system according to an embodiment of the inventive concept.

Referring to FIG. 3, a learning device 300 for a two-stage deep learning based secure precoder for information and an artificial noise signal in a NOMA system may include a pre-training performing unit 310 and a post-training performing unit 320.

The pre-training performing unit 310 and the post-training performing unit 320 may be configured to perform operations 110 and 120 of FIG. 1.

An embodiment of the inventive concept may propose a learning device for a secure precoder considering a channel between a base station and a legitimate user and a maximum transmit power of the system to maximize a sum secrecy rate while ensuring secrecy rates of respective legitimate users, when an eavesdropper attempts to eavesdrop. By designing the secure precoder proposed in an embodiment of the inventive concept, the embodiment of the inventive concept may ensure secrecy rates of the respective legitimate users, which are not considered by the existing downlink precoder design scheme and may maximize a sum secrecy rate, when the eavesdropper attempts to eavesdrop. Furthermore, an embodiment of the inventive concept may propose a practical deep learning based precoder design scheme available irrespective of a position of a legitimate user and a position of an eavesdropper to address a problem of existing high complexity of calculation. In addition, an embodiment of the inventive concept may propose a two-stage secure precoder facilitating more efficient learning in the deep learning precoder to address a problem of a learning time.

The pre-training performing unit 310 may perform pre-training which is a supervised learning scheme for downlink NOMA before information transmission to maximize a sum secrecy rate while ensuring secrecy rates of respective legitimate users, each having a single antenna.

The post-training performing unit 320 may perform post-training which is an unsupervised learning scheme by fine tuning a neural network learned by the pre-training using unsupervised learning.

An embodiment of the inventive concept may propose a scheme of designing a precoder for maximizing a sum secrecy rate while ensuring secrecy rates of respective legitimate users irrespective of positions of the legitimate users and positions of eavesdroppers in a situation where the eavesdropper eavesdrops in the downlink NOMA as a neural network (NN) structure which uses a deep learning technique, which is one of schemes implementing artificial intelligence. A learning scheme for the deep learning precoder may be designed as two-stage learning including a first stage of performing pre-training which is a supervised learning scheme and a second stage of performing post-training which is an unsupervised learning scheme.

When there is another unintended receiver in a network, that is, when there is an eavesdropper, the NOMA system for physical layer security according to an embodiment of the inventive concept may obtain a maximum secrecy rate while ensuring secrecy rates of respective legitimate users, each having a single antenna.

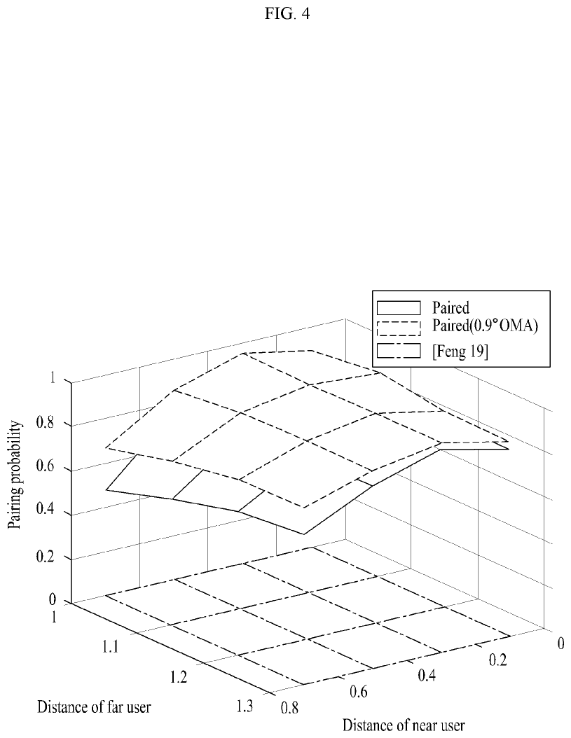

FIG. 4 is a drawing illustrating an experimental result for a pairing success probability according to an embodiment of the inventive concept.

When a secrecy rate capable of being obtained by a precoder made through two-stage deep learning for a certain given legitimate user channel remains higher than a minimum secrecy rate each legitimate user should ensure and when a sum secrecy rate is greater than a minimum sum secrecy rate each legitimate user should ensure, it is regarded as pairing success. An embodiment of the inventive concept performs an experiment on the performance of the pairing probability of a deep learning based precoder by calculating the number of pairs which succeed in pairing among all test samples and deriving the pairing probability.

An embodiment of the inventive concept performs an experiment on deep learning by means of a computer (CPU: AMD Ryzen 7 3700X 8-Core Processor and GPU: NVIDIA GeForce RTX 2080 Ti). In this case, parameters for experimental environments are as follows: The transmit antenna; 4, the transmit power; 10 dB; the distance range from the base station of the near user d₂; 0.1˜0.7, the distance range from the base station of the far user d₁; 1.0˜1.4, the position dₑ of the eavesdropper; 0.2, the number L of hidden layers; 5, the size of each hidden layer (except for the last hidden layer); 2*N(N+2) the size of the last hidden layer; N*(N+2), the learning rate (α); 0.001, the number of learning samples; 40000, the number of test samples; 1000, and the learning epoch; 400.

A minimum secrecy rate respective legitimate users should ensure considers when it is able to obtain an optimal secrecy rate, when using an OMA system. In this case, the reason why the optimal secrecy rate of the OMA system is set to the minimum secrecy rate the respective legitimate users should ensure is because there is no reason to use a new system when the new system does not have better performance than an old OMA system. Thus, a value of the secrecy rate the respective legitimate users should ensure is set to an optimal secrecy rate capable of being obtained by each user in the OMA system.

Referring to FIG. 4, as described above, the probability that respective users will obtain the higher secrecy rate than the optimal secrecy rate capable of being obtained in the OMA system is defined as pairing success. It may be seen that the scheme through two-stage deep learning may obtain even better performance than the [Feng] algorithm which is the latest research of the existing NOMA system as a result of performing an experiment on the pairing probability. When the existing [Feng] scheme does not ensure a secrecy rate of a far user in terms of security, the pairing probability is “0”. However, because the scheme proposed by an embodiment of the inventive concept ensures the secrecy rate of the far user, it is possible to design a precoder capable of addressing a far/near problem in terms of security. Furthermore, although a pairing algorithm is not given in NOMA, it is shown that it is possible to design a precoder robust to a change in position of a legitimate user, which is capable of obtaining a pairing success rate above 75% on average irrespective of a position of a legitimate user in a random pairing situation. Paired (0.9*OMA) on the graph shown in FIG. 4 means that a sum secrecy rate is greater than the sum of optimal values capable of being obtained in OMA while ensuring a level of 90% of the optimal secrecy rate capable of being obtained in the OMA by respective users. In this case, it may be seen that it is possible for the pairing success probability to increase to about 80%.

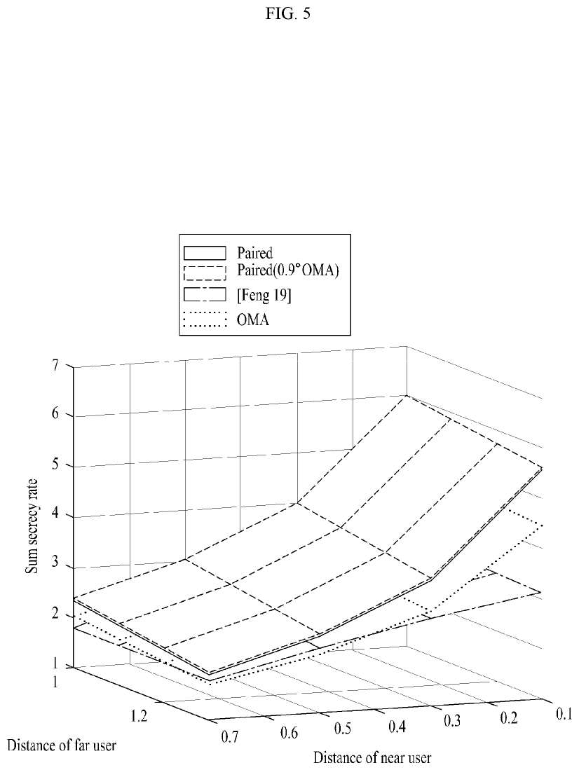

FIG. 5 is a drawing illustrating an experimental result for a sum secrecy rate according to an embodiment of the inventive concept.

An embodiment of the inventive concept performs an experiment on performance of a sum secrecy rate of pairs of legitimate users who succeed in pairing.

Referring to FIG. 5, it may be seen that it is able to obtain a higher secrecy rate than the existing [Feng] algorithm as a result of performing an experiment on the performance of the sum secrecy rate of the pairs of the paired legitimate users who succeed in FIG. 4. Furthermore, it may be seen that it is able to obtain higher performance than an optimal sum secrecy rate capable of being obtained by the existing OMA system.

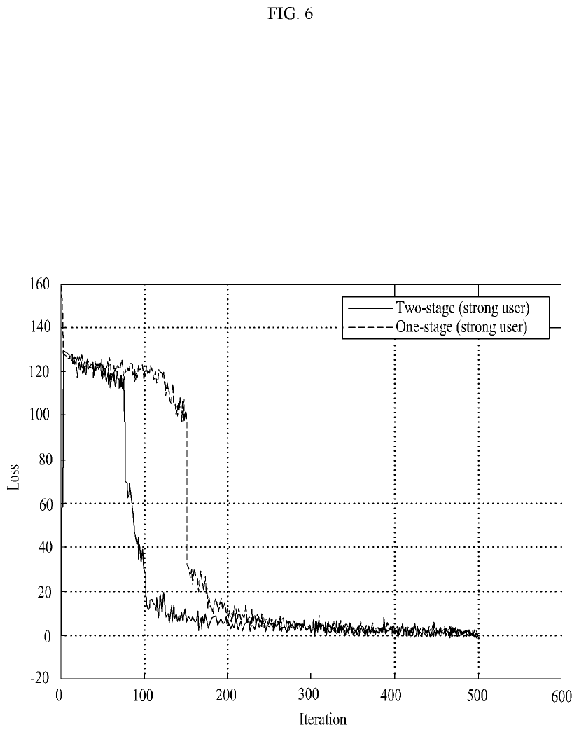

FIG. 6 is a drawing illustrating the result of comparing performance of a two-stage training scheme with performance of a one-stage training scheme using only post-training according to an embodiment of the inventive concept.

An embodiment of the inventive concept performs an experiment on the performance of the two-stage training scheme and the performance of the one-stage training scheme using only the post-training.

Referring to FIG. 6, it is shown that the two-stage training scheme used in an embodiment of the inventive concept is able to obtain a faster convergence result than the one-stage training scheme. In this case, the batch size is 100 and both of two results show an interval where the loss function is saturated. In this case, it may be seen that convergence starts in about 100 iterations in the two-stage training scheme, and it may be seen that convergence starts until about 200 iterations in the one-stage training scheme. It is shown that performing pre-training using the [Feng] algorithm which is the latest scheme in the existing NOMA is able to faster find an optimal point than the initialized neural network.

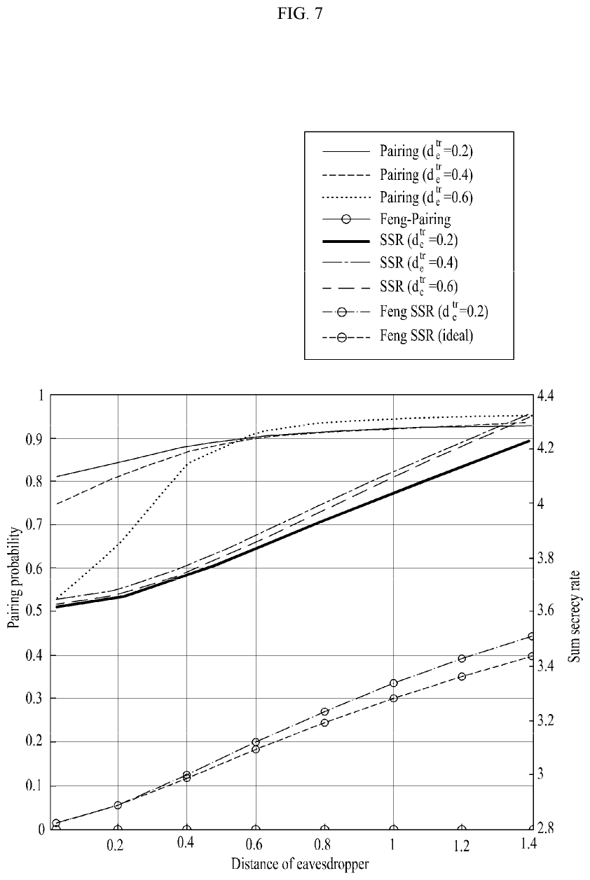

FIG. 7 is a drawing illustrating performance according to a change in position of an eavesdropper according to an embodiment of the inventive concept.

When performing learning in a position of a specific eavesdropper, an embodiment of the inventive concept performs an experiment on performance of a pairing probability and a sum secrecy rate when making a test while changing the position of the eavesdropper. An embodiment of the inventive concept is an experiment on whether it is possible to use a deep learning based precoder of fixing the position of the eavesdropper to dₑ^{tr} to perform learning when the position of the eavesdropper is present in the range of 0.02 to 1.4. As seen as a result of the experiment, an embodiment of the inventive concept may obtain performance of about 135% compared to the existing [Feng] scheme. When using the deep learning based precoder of performing learning in dₑ^{tr}=0.2,0.4 an embodiment of the inventive concept may have the result of the robust pairing probability and the sum secrecy rate irrespective of the position of the eavesdropper.

It may be seen in these experiment results that it is able to obtain a high pairing probability and a high secrecy rate when using the secure precoder by means of deep learning although there is accurate information about specific legitimate users and distance information of the eavesdropper. Because it is difficult to accurate know distance information of specific users in an actually used communication system, it is possible to design a secure precoder having high reliability when using the precoder scheme proposed by an embodiment of the inventive concept.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may perform an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be embodied in any type of machine, components, physical equipment, virtual equipment, or computer storage media or devices so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The computer-readable media may also include, alone or in combination with the program instructions, data files, data structures, and the like. The program instructions recorded in the media may be designed and configured specially for the exemplary embodiments of the inventive concept or be known and available to those skilled in computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

According to embodiments of the inventive concept, it is able to obtain a maximum sum secrecy rate while ensuring a secrecy rate of each legitimate user, which is not addressed by the existing precoder schemes, with regard to a channel between users and the base station and a maximum transmit power allocated to the system. It is able to maximize a sum secrecy rate while addressing a near/far problem on a physical layer of the NOMA system, when there is an eavesdropper. As a result, it is possible to design a precoder capable of performing maximum security transmission while addressing a secrecy fairness problem in the NOMA system which is one of advanced communication systems toward 6G. Furthermore, according to embodiments of the inventive concept, it is possible to provide a new ideal in designing an advanced communication system by aiming for efficiently designing a precoder in the form of being suitable for the advanced communication system using an artificial intelligence scheme. Furthermore, according to embodiments of the inventive concept, the scheme proposed in a 6G wireless communication situation having an advanced communication network structure contributes greatly to communication standardization by improving security performance using artificial intelligence, rather than a design of a mathematical approach conventionally used, in a communication model in which physical layer security recently receiving so much attention in communication standard, patents, theses, and industrial circles and the NOMA technology are combined.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A learning method for a secure precoder, the learning method comprising:
performing pre-training for downlink non-orthogonal multiple access (NOMA) before information transmission to maximize a sum secrecy rate while ensuring secrecy rates of respective legitimate users, each having a single antenna; and
performing post-training by fine tuning a neural network learned by the pre-training using unsupervised learning.

2. The learning method of claim 1, wherein the performing of the pre-training includes:
performing the pre-training using a loss function, and
wherein the loss function is defined with regard to a probability that a secrecy rate obtained by a secure precoder according to a channel of each legitimate user will be less than a secrecy rate the legitimate user should ensure and the secrecy rate obtained by the secure precoder.

3. The learning method of claim 1, wherein a loss function according to the post-training is defined as the following formula, [symbol]
ₚₒₛₜ=−Rₛ₁−Rₛ₂+c₁(max[G₁+ϵ₁−Rₛ₁,0])²+c₂(max[G₂+ϵ₂−Rₛ₂,0])²
where Rₛₖ denotes the achievable secrecy rate for the secure precoder, cₖ denotes the penalty coefficient, and ϵₖ denotes the margin of the secrecy rate of each legitimate user and where k=the first legitimate user 1, the second legitimate user 2, and the artificial noise N.

4. The learning method of claim 3, wherein the performing of the post-training includes:
performing training using the margin of the secrecy rate of each legitimate user to minimize a probability that a secrecy rate obtained by a secure precoder according to a channel of each legitimate user will be less than a secrecy rate the legitimate user should ensure.

5. The learning method of claim 1, further comprising:
updating a weight matrix and a bias vector using a stochastic gradient descent (SGD) scheme, when updating the weight matrix and the bias vector in a backpropagation scheme using a loss function according to the pre-training and a loss function according to the post-training.

6. A learning device for a secure precoder, the learning device comprising:
a pre-training performing unit configured to perform pre-training for downlink non-orthogonal multiple access (NOMA) before information transmission to maximize a sum secrecy rate while ensuring secrecy rates of respective legitimate users, each having a single antenna; and
a post-training performing unit configured to perform post-training by fine tuning a neural network learned by the pre-training using unsupervised learning.

7. The learning device of claim 6, wherein the pre-training performing unit performs the pre-training using a loss function, and
wherein the loss function is defined with regard to a probability that a secrecy rate obtained by a secure precoder according to a channel of each legitimate user will be less than a secrecy rate the legitimate user should ensure and the secrecy rate obtained by the secure precoder.

8. The learning device of claim 6, wherein the post-training performing unit defines a loss function according to the post-training as the following formula, [symbol]
ₚₒₛₜ=−Rₛ₁−Rₛ₂+c₁(max[G₁+ϵ₁−Rₛ₁,0])²+c₂(max[G₂+ϵ₂−Rₛ₂,0])²
where Rₛₖ denotes the achievable secrecy rate for the secure precoder, cₖ denotes the penalty coefficient, and ϵₖ denotes the margin of the secrecy rate of each legitimate user and where k=the first legitimate user 1, the second legitimate user 2, and the artificial noise N.

9. The learning device of claim 8, wherein the post-training performing unit performs training using the margin of the secrecy rate of each legitimate user to minimize a probability that a secrecy rate obtained by a secure precoder according to a channel of each legitimate user will be less than a secrecy rate the legitimate user should ensure.

10. The learning device of claim 6, wherein a weight matrix and a bias vector are updated using a stochastic gradient descent (SGD) scheme, when updating the weight matrix and the bias vector in a backpropagation scheme using a loss function according to the pre-training and a loss function according to the post-training.

11. A learning method for a secure precoder, the learning method comprising:
performing secure precoding using an artificial intelligence method by means of a precoder of maximizing secrecy rates of respective legitimate users and a sum secrecy rate irrespective of positions of legitimate users and positions of eavesdroppers, when the eavesdropper eavesdrops, in a downlink non-orthogonal multiple access (NOMA) method.

12. The learning method of claim 11, wherein the artificial intelligence method includes a method designed as a neural network (NN) structure which uses deep learning, and
wherein a learning method for a precoder which uses the artificial intelligence method includes performing pre-training which is a supervised learning method and performing post-training which is an unsupervised learning method.

13. The learning method of claim 12, wherein the performing of the pre-training includes:
performing the pre-training by means of downlink non-orthogonal multiple access (NOMA) before information transmission to maximize a sum secrecy rate while ensuring secrecy rates of respective legitimate users, each having a single antenna.

14. The learning method of claim 12, wherein the performing of the post-training includes:
performing the post-training by fine tuning a neural network learned by the pre-training using unsupervised learning.

15. The learning method of claim 11, further comprising:
performing training using a margin of a secrecy rate of each legitimate user to minimize a probability that a secrecy rate obtained by a secure precoder according to a channel of each legitimate user will be less than a secrecy rate the legitimate user should ensure; and
updating a weight matrix and a bias vector using a stochastic gradient descent (SGD) method, when updating the weight matrix and the bias vector in a backpropagation method using a loss function according to pre-training and a loss function according to post-training.

16. A learning method for a secure precoder, the learning method comprising:
performing pre-training for downlink non-orthogonal multiple access (NOMA) before information transmission to maximize a sum secrecy rate while ensuring secrecy rates of respective legitimate users, each having a single antenna; and
performing post-training by fine tuning a neural network learned by the pre-training using unsupervised learning,
wherein the performing of the post-training includes:
performing training using a margin of a secrecy rate of each legitimate user to minimize a probability that a secrecy rate obtained by a secure precoder according to a channel of each legitimate user will be less than a secrecy rate the legitimate user should ensure.
